(19) United States
(12) Patent Application Publication
(10) Pub. No.: US 2026/0270634 A1
(43) Pub. Date: Sep. 10, 2026

(54) HEADSET DETECTION METHOD THAT CAN ADAPTIVELY OPTIMIZE DETECTION TIME AND ASSOCIATED SIGNAL PROCESSING DEVICE

(71) Applicant: Realtek Semiconductor Corp., HsinChu (TW)

(72) Inventors: Quan-Xi Yang, HsinChu (TW); Cheng-Pin Chang, HsinChu (TW); Hong-Cheng Tsai, HsinChu (TW)

(73) Assignee: Realtek Semiconductor Corp., HsinChu (TW)

(21) Appl. No.: 19/529,121

(22) Filed: Feb. 4, 2026

(30) Foreign Application Priority Data
Mar. 4, 2025 (TW) 114107800

(51) Int. Cl. H04R 29/00

(52) U.S. Cl. CPC H04R 29/00

(57) ABSTRACT

A signal processing device is coupled to an audio jack, and includes a detection controller and an analog-to-digital converter (ADC). The detection controller controls a bias circuit to provide a bias voltage to the audio jack in response to a trigger signal indicating that a device is plugged into the audio jack. The ADC is coupled to a detection point of the audio jack, and performs an analog-to-digital conversion operation upon a voltage of the detection point in order to generate an output voltage. The detection controller detects a voltage difference of the output voltage captured from the ADC at different times, and determines whether the voltage difference is less than a threshold value. In response to the voltage difference being less than the threshold value, the detection controller determines that the device is a headphone without a microphone.

### BACKGROUND OF THE INVENTION

### 1. Field of the Invention

The present invention is related to a detection method for a headset and a corresponding signal processing device, and more particularly, to a headset detection method that can adaptively optimize the detection time and an associated signal processing device.

### 2. Description of the Prior Art

A 3.5 mm headphone connector is a commonly used headphone connector that supports both headphones and headsets. In current electronic product mechanical designs, devices that support both audio playback and audio recording are typically equipped with a single audio jack, which allows a user to plug either a headphone or a headset into the audio jack. Therefore, it is necessary to detect whether the plugged device is a headphone or a headset.

Headsets from different brands or manufacturers often use different electronic components, resulting in varying electrical characteristics. This increases the difficulty of quickly and accurately detecting the device type.

### SUMMARY OF THE INVENTION

It is therefore one of the objectives of the present invention to provide a headset detection method that can adaptively optimize the detection time and an associated signal processing device, in order to address the above-mentioned issues.

According to an embodiment of the present invention, a signal processing device is provided. The signal processing device is coupled to an audio jack, and comprises a detection controller and an analog-to-digital converter (ADC). The detection controller is arranged to control a bias circuit to provide a bias voltage to the audio jack in response to a trigger signal indicating that a device is plugged into the audio jack. The ADC is coupled to a detection point of the audio jack, and is arranged to perform an analog-to-digital conversion operation upon a voltage of the detection point in order to generate an output voltage. The detection controller detects a voltage difference of the output voltage captured from the ADC at different times, and determines whether the voltage difference is less than a threshold value. In response to the voltage difference being less than the threshold value, the detection controller determines that the device is a headphone without a microphone.

According to an embodiment of the present invention, a detection method for detecting a device plugged into an audio jack of an electronic device is provided. The detection method comprises: controlling a bias circuit to provide a bias voltage to the audio jack in response to a trigger signal indicating that the device is plugged into the audio jack; performing an analog-to-digital conversion operation upon a voltage of a detection point of the audio jack in order to generate an output voltage; detecting a voltage difference of the output voltage at different times and determining whether the voltage difference is less than a threshold value; and in response to the voltage difference being less than the threshold value, determining that the device is a headphone without a microphone.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an example of a 3.5 mm headphone connector.

FIG. 2 is a block diagram of a signal processing device according to an embodiment of the present invention.

FIG. 3 is a diagram illustrating an example of voltage detection.

FIG. 4 is a diagram illustrating another example of voltage detection.

FIG. 5 is a flow chart of a detection method for detecting a device plugged into an audio jack of an electronic device according to an embodiment of the present invention.

FIG. 6 is a detailed flow chart of a detection method according to an embodiment of the present invention.

FIG. 7 is a detailed flow chart of a detection method according to another embodiment of the present invention.

### DETAILED DESCRIPTION

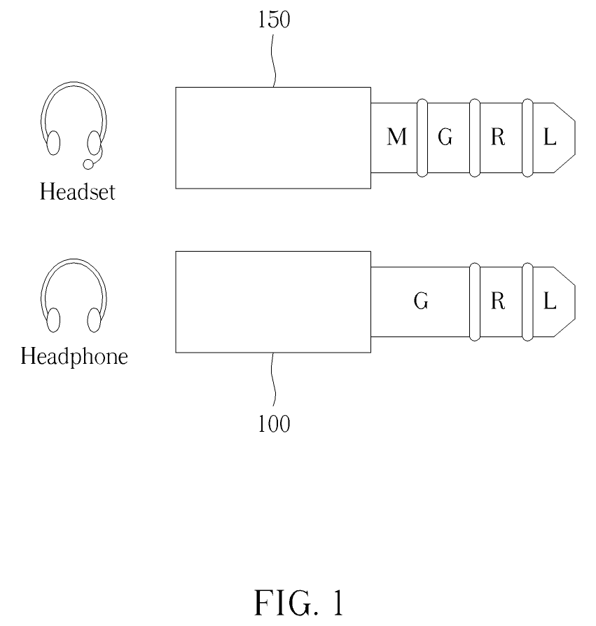

FIG. 1 is a diagram illustrating an example of a 3.5 mm headphone connector. The difference between headphone connectors 100 and 150 corresponding to two types of devices (e.g., a headphone and a headset) is shown in FIG. 1. The headphone connector 100 corresponds to the headphone, and includes three metal rings comprising an L metal ring, an R metal ring, and a G metal ring, wherein “L” represents the left channel, “R” represents the right channel, and “G” represents the ground. The headphone connector 150 corresponds to the headset, and includes four metal rings comprising an L metal ring, an R metal ring, a G metal ring, and an M metal ring, wherein “M” represents the microphone. Since the configurations of the metal rings on the headphone connector are different, when a user plugs a headphone connector into an audio jack, it is necessary to detect whether the plugged device is a headphone or a headset.

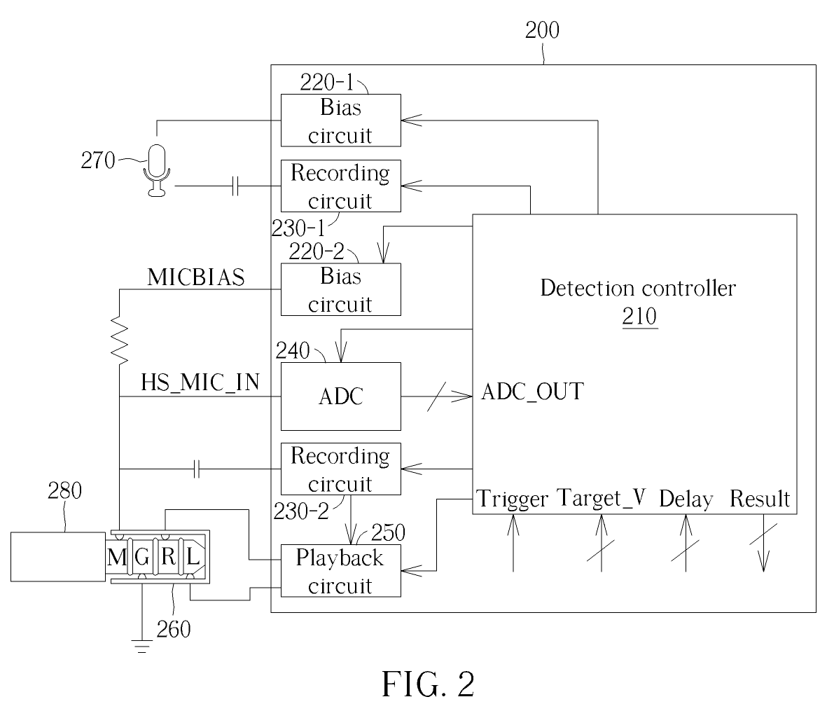

FIG. 2 is a block diagram of a signal processing device 200 according to an embodiment of the present invention. According to an embodiment of the present invention, the signal processing device 200 may be a signal processor (e.g., an audio signal processor) or a signal processing chip disposed in an electronic device. The signal processing device 200 may be coupled to an audio jack 260 of the electronic device in order to detect whether a device is plugged into the audio jack 260 and further detect whether the device is a headphone or a headset including a microphone. In addition, the signal processing device 200 may be further arranged to process an audio signal output to a plugged headphone or an audio signal received from a plugged headset, and process an audio signal received by the electronic device (e.g., an audio signal sensed or captured by a microphone 270 integrated in the electronic device).

According to an embodiment of the present invention, the signal processing device 200 may include a detection controller 210, processing circuits associated with the microphone 270 (e.g., a bias circuit 220-1 and a recording circuit 230-1), and processing circuits associated with the audio jack 260 (e.g., a bias circuit 220-2, a recording circuit 230-2, an analog-to-digital converter (ADC) 240, and a playback circuit 250).

The bias circuit 220-1 may be enabled by the detection controller 210 for providing a bias voltage to the microphone 270. The bias circuit 220-2 may be enabled by the detection controller 210 for providing a bias voltage MICBIAS to the audio jack 260. Specifically, the bias circuit 220-2 may provide the bias voltage MICBIAS to a connection point within the audio jack 260 that is electrically connected to an M metal ring of a headphone connector 280, such as a connection point disposed on the inner wall of the audio jack 260 that can contact the M metal ring (e.g., a triangle drawn on the inner wall of the audio jack 260 that can contact the M metal ring in FIG. 2).

The recording circuit 230-1 may be enabled by the detection controller 210 for recording or storing signals sensed or captured by the microphone 270. The recording circuit 230-2 may be enabled by the detection controller 210 for recording or storing signals sensed or captured by a microphone of a headset when the headset is plugged into the audio jack 260.

The ADC 240 may be enabled by the detection controller 210, and may be coupled to a detection point of the audio jack 260. For example, the ADC 240 may be coupled to a detection point disposed on the inner wall of the audio jack 260 that can contact the M metal ring, and may be arranged to perform an analog-to-digital conversion operation upon a voltage HS_MIC_IN of the detection point in order to generate an output voltage ADC_OUT. The ADC 240 may perform an analog-to-digital conversion operation upon an analog voltage signal sensed or captured by a microphone of a headset in order to generate a digital voltage signal.

The playback circuit 250 may be enabled by the detection controller 210, and may be coupled to connection points in the audio jack 260 that are electrically connected to the L metal ring and the R metal ring on the headphone connector 280 (e.g., triangles on the inner wall of the audio jack 260 that can contact the L metal ring and the R metal ring in FIG. 2), for outputting audio signals to be played by the electronic device. The signal processing device 200 may be connected to the metal rings on the headphone connector 280 via the above-mentioned connection points on the inner wall of the audio jack 260, for transmitting signals between the signal processing device 200 and the headphone connector 280.

According to an embodiment of the present invention, before a detection operation is performed, an external device (e.g., a processor of the electronic device) may set a target voltage value Target_V and a time delay “Delay” for detecting a plugged device. In addition, the signal processing device 200 may further include a plugged event detection circuit (not shown in FIG. 2). The plugged event detection circuit may detect whether a device is plugged into the audio jack 260, and transmit a trigger signal “Trigger” to the detection controller 210 when a device is detected to be plugged into the audio jack 260, in order to trigger the detection controller 210 to start detecting whether the plugged device is a headphone or a headset including a microphone.

According to an embodiment of the present invention, the detection controller 210 may control the bias circuit 220-2 to provide the bias voltage MICBIAS to the audio jack 260 in response to the trigger signal “Trigger”. In response to the plugged device being a headset including a microphone, the bias voltage MICBIAS may charge capacitors of the microphone, which causes the voltage HS_MIC_IN of the detection point to increase. In response to the plugged device being a headphone without a microphone, the voltage HS_MIC_IN of the detection point will not increase.

The detection controller 210 may determine whether the plugged device is a headset including a microphone according to whether the voltage HS_MIC_IN of the detection point or the output voltage ADC_OUT of the ADC 240 reaches the target voltage value Target_V, and correspondingly generate a detection result “Result”.

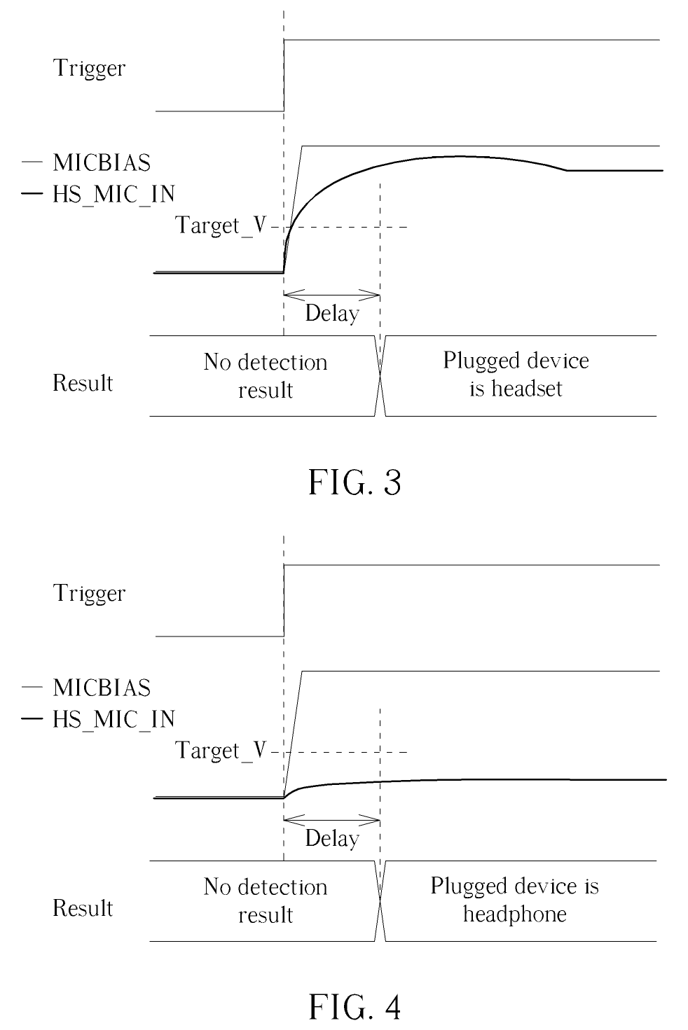

FIG. 3 is a diagram illustrating an example of voltage detection. In response to the activation of the trigger signal “Trigger” (e.g., when the voltage level of the trigger signal “Trigger” is pulled high), the bias voltage MICBIAS is provided to the audio jack 260. After the bias voltage MICBIAS is provided, the detection controller 210 waits for a predetermined time (e.g., the time delay “Delay”), reads or captures the output voltage ADC_OUT of the ADC 240 in order to determine whether the voltage HS_MIC_IN of the detection point has been charged to a voltage level greater than or equal to the target voltage value Target_V, and correspondingly generates the detection result “Result”.

As shown in FIG. 3, since the voltage level of the voltage HS_MIC_IN is greater than the target voltage value Target_V after the time delay “Delay”, the detection controller 210 may determine the plugged device is a headset including a microphone, and correspondingly generate the detection result “Result” indicating that the plugged device is the headset.

FIG. 4 is a diagram illustrating another example of voltage detection. In response to the activation of the trigger signal “Trigger” (e.g., when the voltage level of the trigger signal “Trigger” is pulled high), the bias voltage MICBIAS is provided to the audio jack 260. After the bias voltage MICBIAS is provided, the detection controller 210 waits for a predetermined time (e.g., the time delay “Delay”), reads or captures the output voltage ADC_OUT of the ADC 240 in order to determine whether the voltage HS_MIC_IN of the detection point has been charged to a voltage level greater than or equal to the target voltage value Target_V, and correspondingly generates the detection result “Result”.

As shown in FIG. 4, since the voltage level of the voltage HS_MIC_IN is less than the target voltage value Target_V after the time delay “Delay”, the detection controller 210 may determine the plugged device is a headphone without a microphone, and correspondingly generate the detection result “Result” indicating that the plugged device is the headphone.

As mentioned above, headsets from different brands or manufacturers often use different electronic components, resulting in varying electrical characteristics. For example, different headsets may have different equivalent impedances or different capacitive properties. If the detection operation is performed based solely on the predetermined time delay “Delay”, a balance between the detection speed and the detection accuracy is difficult to achieve. Assume that the headset plugged into the audio jack 260 has a large internal capacitance, which requires a longer charging time. If the predetermined time delay “Delay” is not sufficient for the voltage HS_MIC_IN of the detection point to charge to a voltage level equal to or greater than the target voltage value Target_V, the detection controller 210 may generate an incorrect detection result. In addition, increasing the delay time “Delay” to improve the detection accuracy may lead to a prolonged startup time of the electronic device, which affects the user experience.

Therefore, in order to ensure a better user experience and optimize the detection performance for achieving a balance between the detection speed and the detection accuracy for a headset, the present invention proposes a headset detection method that can adaptively optimize the detection time and a corresponding signal processing device (e.g., the signal processing device 200 shown in FIG. 2).

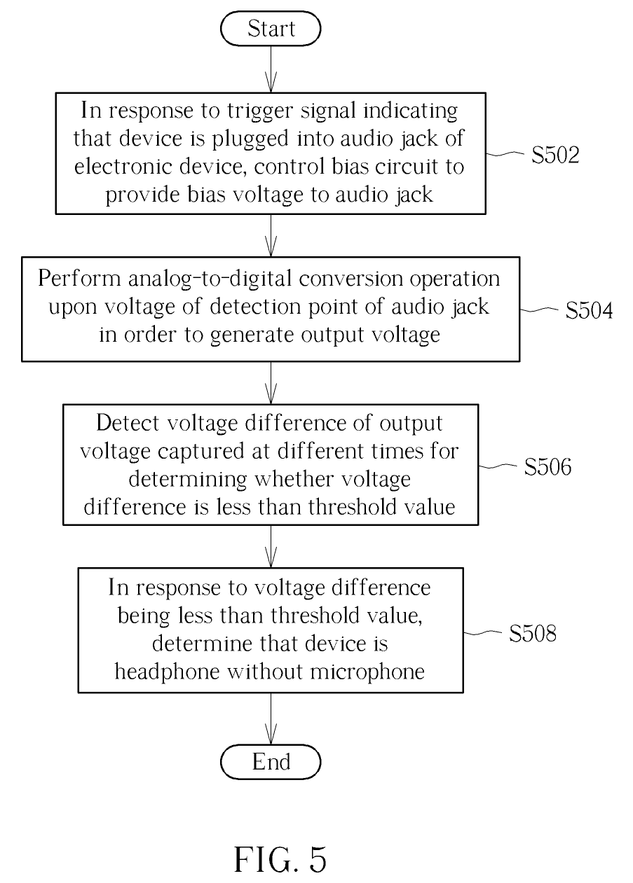

FIG. 5 is a flow chart of a detection method for detecting a device plugged into an audio jack of an electronic device according to an embodiment of the present invention. The detection method includes the following steps performed by the signal processing device 200.

In Step S502, in response to a trigger signal indicating that a device is plugged into an audio jack of an electronic device, a bias circuit is controlled to provide a bias voltage to the audio jack.

In Step S504, an analog-to-digital conversion operation is performed upon a voltage of a detection point of the audio jack in order to generate an output voltage.

In Step S506, a voltage difference of the output voltage captured at different times is detected for determining whether the voltage difference is less than a threshold value.

In Step S508, in response to the voltage difference being less than the threshold value, it is determined that the device is a headphone without a microphone.

FIG. 5 illustrates a detection method for detecting a device plugged into an audio jack according to a time-division voltage difference. The threshold value can be set to a value sufficient to identify a rise in the output voltage, or can be set to a value sufficient to distinguish between a definite voltage increase in the output voltage and mere voltage fluctuations at the detection point.

In an embodiment of the present invention, after the determination in Step S506 and in response to the voltage difference not being less than the threshold value, the signal processing device 200 may determine that the device is a headset including a microphone.

In an embodiment of the present invention, the signal processing device 200 may combine the time-division voltage difference with the real-time voltage detection in order to detect the device plugged into the audio jack, for further increasing the detection accuracy. After the determination in Step S506, in response to the voltage difference not being less than the threshold value, the signal processing device 200 may be further arranged to monitor a voltage level of an output voltage during a real-time voltage detection period (e.g., repeatedly capture the voltage level of the output voltage during the real-time voltage detection period), and determine whether the voltage level is greater than a target value (e.g., the target voltage value Target_V). In response to the voltage level being greater than the target value, the signal processing device 200 may determine that the device is a headset. In response to the voltage level not being greater than the target value until the real-time voltage detection period exceeds, the signal processing device 200 may determine that the device is a headphone without a microphone.

According to an embodiment of the present invention, before Step S506 is performed, the signal processing device 200 may capture a voltage level of an output voltage as a charging level in advance at an initial detection time (e.g., after waiting for the time delay “Delay”), and determine whether the charging level is greater than a target value (e.g., the target voltage value Target_V). In response to the charging level being greater than the target value, the signal processing device 200 may determine that the device is a headset. In response to the charging level not being greater than the target value, the signal processing device 200 may perform Step S506. That is, operations of detecting a voltage difference of an output voltage at different times and determining whether the voltage difference is less than a threshold value (i.e., Step S506) can be performed after determining that the charging level is not greater than the target value.

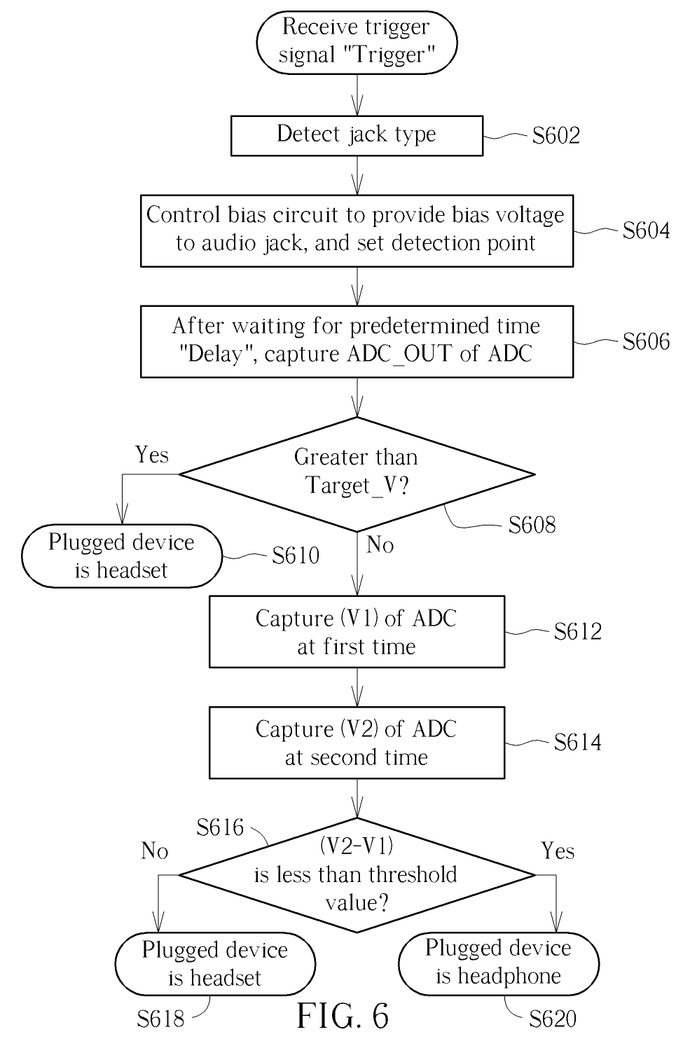

FIG. 6 is a detailed flow chart of a detection method according to an embodiment of the present invention. The detection method may begin when the detection controller 210 receives a trigger signal “Trigger” indicating that a device is plugged into an audio jack, and may include the following operations/steps.

In Step S602, a jack type is detected by the detection controller 210. For example, the detection controller 210 detects whether an audio jack is a combo jack (CBJ). The metal ring configuration of different types of audio jacks may vary. For example, the positions of the M metal ring and the G metal ring may be different. As a result, the detection controller 210 may first detect the jack type in order to determine the positions of the M metal ring and the G metal ring.

In Step S604, the bias circuit 220-2 is controlled by the detection controller 210 to provide a bias voltage to the audio jack, and a detection point for detecting a voltage level of the M metal ring is set. For example, according to a detection result of the jack type, the ADC 240 is configured to perform an analog-to-digital conversion operation upon a voltage at a specific detection point in order to generate the output voltage ADC_OUT, and is configured to perform an analog-to-digital conversion operation upon a voltage at another detection point in order to generate a corresponding voltage signal for the detection controller 210 to interpret as an audio signal.

In Step S606, after waiting for a predetermined time (e.g., the predetermined time delay “Delay”), the output voltage ADC_OUT of the ADC 240 is captured by the detection controller 210. According to an embodiment of the present invention, the performing time of Step S606 can be regarded as an initial detection time, and the detection controller 210 may capture a voltage level of the output voltage as a charging level at the initial detection time.

In Step S608, it is determined by the detection controller 210 whether the charging level is greater than the target voltage value Target_V. If Yes, Step S610 is entered; if No, Step S612 is entered.

In Step S610, the plugged device is determined as a headset by the detection controller 210.

According to an embodiment of the present invention, in response to the charging level not being greater than the target voltage value Target_V, the detection controller 210 does not directly determine that the plugged device is a headphone, but instead performs Steps S612 – S620 to detect the plugged device for further determining whether the plugged device truly lacks a microphone or includes a high-capacitance type microphone.

According to an embodiment of the present invention, since the microphone capacitance causes the voltage at the detection point to change during the charging process, the detection controller 210 may detect a voltage difference of the output voltage ADC_OUT and determine whether the voltage difference is less than a threshold value.

In Step S612, the output voltage ADC_OUT of the ADC 240 is read or captured at a first time by the detection controller 210 for acting as a first voltage (V1), or a voltage level of the output voltage ADC_OUT is read or captured as a first level. According to an embodiment of the present invention, after waiting for another predetermined time, the detection controller 210 may again read or capture the voltage level of the output voltage ADC_OUT for acting as the first voltage (V1). According to another embodiment of the present invention, in Step S612, an output voltage obtained at the initial detection time can be recorded by the detection controller 210 as the first voltage (V1). That is, the charging level is set as the first level. In some embodiments, the first time may be equal to or close to the initial detection time.

In Step S614, the output voltage ADC_OUT of the ADC 240 is read or captured at a second time by the detection controller 210 for acting as a second voltage (V2), or a voltage level of the output voltage ADC_OUT is read or captured as a second level. In embodiments of the present invention, the second time is not equal to the first time. After Step S612 is performed, the detection controller 210 may wait for another predetermined time and then perform Step S614.

In Step S616, it is determined by the detection controller 210 whether a voltage difference (V2 – V1) is less than a threshold value (i.e., determine whether a difference value between the first level and the second level is less than a threshold value). If Yes, Step S620 is entered; if No, Step S618 is entered.

In Step S618, the plugged device is determined as a headset by the detection controller 210.

In Step S620, the plugged device is determined as a headphone by the detection controller 210.

In another embodiment of the present invention, the signal processing device 200 may combine the time-division voltage difference with the real-time voltage detection in order to detect the device plugged into the audio jack, for further increasing the detection accuracy.

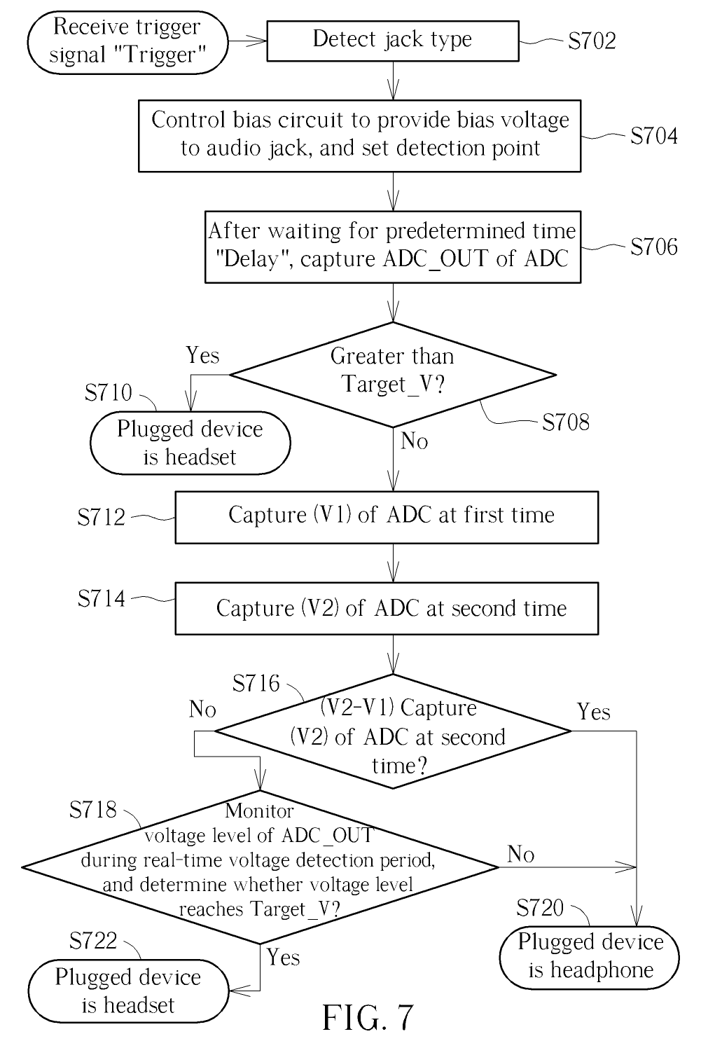

FIG. 7 is a detailed flow chart of a detection method according to another embodiment of the present invention. In this embodiment, since operations of Step S702 – S716 are similar to those of Step S602 – S616 shown in FIG. 6, detailed descriptions are not repeated here for brevity. The detection method may begin when the detection controller 210 receives a trigger signal “Trigger” indicating that a device is plugged into an audio jack, and may include the following operations/steps.

In Step S702, a jack type is detected by the detection controller 210.

In Step S704, the bias circuit 220-2 is controlled by the detection controller 210 to provide a bias voltage to the audio jack, and a detection point for detecting a voltage level of the M metal ring is set.

In Step S706, after waiting for a predetermined time (e.g., the predetermined time delay “Delay”), the output voltage ADC_OUT of the ADC 240 is captured by the detection controller 210.

In Step S708, it is determined by the detection controller 210 whether the charging level is greater than the target voltage value Target_V. If Yes, Step S710 is entered; if No, Step S712 is entered.

In Step S710, the plugged device is determined as a headset by the detection controller 210.

In Step S712, the output voltage ADC_OUT of the ADC 240 is read or captured at a first time by the detection controller 210 for acting as a first voltage (V1), or a voltage level of the output voltage ADC_OUT is read or captured as a first level.

In Step S714, the output voltage ADC_OUT of the ADC 240 is read or captured at a second time by the detection controller 210 for acting as a second voltage (V2), or a voltage level of the output voltage ADC_OUT is read or captured as a second level, wherein the second time is not equal to the first time.

In Step S716, by the detection controller 210, it is determined whether a voltage difference (V2 – V1) is less than a threshold value (i.e., determine whether a difference value between the first level and the second level is less than a threshold value). If Yes, it is determined that the plugged device does not have microphone characteristics, and Step S720 is entered; if No, it is preliminarily determined that the plugged device has microphone characteristics, and Step S718 is entered.

In Step S718, a voltage level of the output voltage ADC_OUT is monitored by the detection controller 210 during a real-time voltage detection period, and it is determined whether the voltage level reaches the target voltage value Target_V. For example, the detection controller 210 may determine whether the voltage level of the output voltage ADC_OUT is greater than or equal to the target voltage value Target_V.

According to an embodiment of the present invention, the detection controller 210 may repeatedly capture the voltage level of the output voltage ADC_OUT during the real-time voltage detection period in order to monitor the voltage level of the output voltage ADC_OUT. That is, during the real-time voltage detection period, Step S718 can be performed more than one time. The detection controller 210 may stop performing Step S718 until the voltage level of the output voltage ADC_OUT reaches the target voltage value Target_V, and then perform Step S722. In this way, the detection time can be adaptively optimized.

According to an embodiment of the present invention, the detection controller 210 may repeatedly capture the voltage level of the output voltage ADC_OUT at a predetermined time interval during the real-time voltage detection period, in order to monitor the voltage level of the output voltage ADC_OUT. It should be noted that the predetermined time interval may be fixed, and may also be unfixed or dynamically adjustable. For example, the detection controller 210 may capture the voltage level of the output voltage ADC_OUT multiple times at a fixed time interval, or may capture the voltage level of the output voltage ADC_OUT multiple times based on an unfixed time interval. In some embodiments, Step S718 may be performed multiple times during the real-time voltage detection period, and may also be performed one time during the real-time voltage detection period. For example, for the first capture of the output voltage ADC_OUT during the real-time voltage detection period, if the detection controller 210 determines that the voltage level of the output voltage ADC_OUT has reached the target voltage value Target_V, Step S718 ends and Step S722 is entered.

According to an embodiment of the present invention, if the voltage level of the output voltage ADC_OUT does not reach the target voltage value Target_V until the real-time voltage detection period exceeds, Step S718 ends and Step S720 is entered.

In Step S720, the plugged device is determined as a headphone by the detection controller 210.

In Step S722, the plugged device is determined as a headset by the detection controller 210.

According to an embodiment of the present invention, after the plugged device is determined as a headphone or a headset by the detection controller 210 (e.g., after Steps S610, S618, and S620 (or Step S710, S720, and S722) are performed), the detection controller 210 may correspondingly control relevant processing circuits to enable required circuits and disable unnecessary circuits based on the determination result in order to achieve power-saving effects. For example, in response to the plugged device being determined to be a headphone, the detection controller 210 may enable the bias circuit 220-1, the recording circuit 230-1, and the playback circuit 250, and disable the bias circuit 220-2, the recording circuit 230-2, and the ADC 240. In response to the plugged device being determined to be a headset, the detection controller 210 may enable the bias circuit 220-2, the recording circuit 230-2, the ADC 240, and the playback circuit 250, and disable the bias circuit 220-1 and the recording circuit 230-1.

In embodiments of the present invention, there is no need to extend the time delay “Delay” for meeting requirements of a small number of headsets with large capacitance characteristics. That is, the time delay “Delay” can still be set to a value optimized for fast detection based on the characteristics of the majority of headsets. For headsets with large capacitance, the charging level may fail to exceed the target value due to the insufficient time delay “Delay”, resulting in a potentially incorrect detection result. In this case, the device type can be further identified with the assistance of time-division voltage difference, thereby preventing the detection controller 210 from generating an incorrect detection result.

In addition, when the time-division voltage difference is not less than the threshold value, it can be preliminarily determined that the plugged device has microphone characteristics, and the real-time voltage detection can be used in combination to accurately determine whether the plugged device is a headset. By using a detection method based on the time-division voltage difference, the real-time voltage detection, or a combination of the time-division voltage difference and the real-time voltage detection, the device plugged into the audio jack can be detected with adaptively optimized detection time. In this way, extended device startup time caused by overly long detection periods can be prevented, and a balance between the speed and accuracy of headset detection can be achieved, thereby improving the overall user experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A signal processing device, coupled to an audio jack, comprising:
a detection controller, arranged to control a bias circuit to provide a bias voltage to the audio jack in response to a trigger signal indicating that a device is plugged into the audio jack; and
an analog-to-digital converter (ADC), coupled to a detection point of the audio jack, and arranged to perform an analog-to-digital conversion operation upon a voltage of the detection point in order to generate an output voltage;
wherein the detection controller detects a voltage difference of the output voltage captured from the ADC at different times, and determines whether the voltage difference is less than a threshold value; and in response to the voltage difference being less than the threshold value, the detection controller determines that the device is a headphone without a microphone.

2. The signal processing device of claim 1, wherein in response to the voltage difference not being less than the threshold value, the detection controller determines that the device is a headset comprising the microphone.

3. The signal processing device of claim 1, wherein in response to the voltage difference not being less than the threshold value, the detection controller is further arranged to monitor a voltage level of the output voltage during a real-time voltage detection period, and determine whether the voltage level is greater than a target value; and in response to the voltage level being greater than the target value, the detection controller determines that the device is a headset comprising the microphone.

4. The signal processing device of claim 3, wherein the detection controller repeatedly captures the voltage level of the output voltage during the real-time voltage detection period in order to monitor the voltage level of the output voltage.

5. The signal processing device of claim 1, wherein the detection controller is further arranged to capture a voltage level of the output voltage from the ADC at an initial detection time for acting as a charging level, and determine whether the charging level is greater than a target value; and in response to the charging level not being greater than the target value, the detection controller detects the voltage difference and determines whether the voltage difference is less than the threshold value.

6. The signal processing device of claim 5, wherein in response to the charging level being greater than the target value, the detection controller determines that the device is a headset comprising the microphone.

7. The signal processing device of claim 1, wherein the detection controller is further arranged to capture a voltage level of the output voltage at a first time for acting as a first level, capture the voltage level of the output voltage at a second time for acting as a second level, and determine whether a difference value between the first level and the second level is less than the threshold value.

8. A detection method for detecting a device plugged into an audio jack of an electronic device, comprising:
controlling a bias circuit to provide a bias voltage to the audio jack in response to a trigger signal indicating that the device is plugged into the audio jack;
performing an analog-to-digital conversion operation upon a voltage of a detection point of the audio jack in order to generate an output voltage;
detecting a voltage difference of the output voltage at different times and determining whether the voltage difference is less than a threshold value; and
in response to the voltage difference being less than the threshold value, determining that the device is a headphone without a microphone.

9. The detection method of claim 8, further comprising:
in response to the voltage difference not being less than the threshold value, determining that the device is a headset comprising the microphone.

10. The detection method of claim 8, further comprising:
in response to the voltage difference not being less than the threshold value, monitoring a voltage level of the output voltage during a real-time voltage detection period, and determining whether the voltage level is greater than a target value; and
in response to the voltage level being greater than the target value, determining that the device is a headset comprising the microphone.

11. The detection method of claim 10, wherein the step of monitoring the voltage level of the output voltage during the real-time voltage detection period further comprises:
repeatedly capturing the voltage level of the output voltage during the real-time voltage detection period.

12. The detection method of claim 8, further comprising:
capturing a voltage level of the output voltage at an initial detection time for acting as a charging level; and
determining whether the charging level is greater than a target value;
wherein the step of detecting the voltage difference of the output voltage at different times and determining whether the voltage difference is less than the threshold value is performed after the charging level is determined to not be greater than the target value.

13. The detection method of claim 12, further comprising:
in response to the charging level being greater than the target value, determining that the device is a headset comprising the microphone.

14. The detection method of claim 8, wherein the step of detecting the voltage difference of the output voltage at different times and determining whether the voltage difference is less than the threshold value further comprises:
capturing a voltage level of the output voltage at a first time for acting as a first level;
capturing the voltage level of the output voltage at a second time for acting as a second level; and
determining whether a difference value between the first level and the second level is less than the threshold value.
